(19) United States
(12) Patent Application Publication
(10) Pub. No.: US 2002/0104668 A1
(43) Pub. Date: Aug. 8, 2002

(54) Method and apparatus for making an electrical distribution conductor and resultant product

(75) Inventors: Albert Wojewnik, Royal Oak, MI (US); David Lee Perry, Rochester Hills, MI (US)

Correspondence Address: James A. Kushman, Brooks & Kushman P.C., 1000 Town Center, 22nd Floor, Southfield, MI, 48075-1351, US

(73) Assignee: Lear Corporation, Southfield, MI

(21) Appl. No.: 10/114,751

(22) Filed: Apr. 2, 2002

Related U.S. Application Data
(63) Continuation-in-part of application No. 09/563,766, filed on May 1, 2000.

(51) Int. Cl. H01R 43/00; H01B 9/00

(52) U.S. Cl. 174/24; 29/868; 29/745; 174/27

(57) ABSTRACT

A method and apparatus (10) for making an electrical distribution conductor (12) is performed by heating an electrically conductive uninsulated wire (14) to a predetermined temperature that is at least approximately as hot as the melting temperature of a thermoplastic member (15) and by then forcing the heated wire into the thermoplastic member to provide insulated mounting of the wire for providing an electrical conductor between spaced locations. The wire (14) is engaged with a pair of spaced rotary electrodes (20, 22) to pass an electric current through the wire to provide its heating. The wire (14) can be either fully or partially embedded within the thermoplastic member (15) and can have either electrically connected or insulated junctions with another crossing wire.

### CROSS-REFERENCE TO RELATED APPLICATIONS

This application is a continuation-in-part of pending prior U.S. application Ser. No. 09/563,766 filed by David Lee Perry on May 1, 2000 under the title METHOD AND APPARATUS FOR MAKING AN ELECTRICAL DISTRIBUTION CONDUCTOR AND RESULTANT PRODUCT.

### BACKGROUND OF THE INVENTION

1. Field of the Invention

This invention relates to a method and apparatus for making an electrical distribution conductor and also relates to the resultant product which has particular utility for use in vehicles.

2. Background Art

Current production vehicles have electrical distribution systems including wiring harnesses and various junction boxes. Such wiring harnesses are conventionally composed of multiple circuits including insulated stranded copper wires that are bundled together using various forms of cable wrapping material such as polyvinyl chloride wrap or electrical tape. Connectors are attached to the ends of the wires and the harness is secured with different types of attachment devices for installation into the associated vehicle component such as within a door panel or the space frame of the vehicle body. The wires utilized in such harnesses are conventionally of a larger gauge than required for the electrical current carried so as to have the requisite physical strength and durability required to withstand the vibration involved with a vehicle environment. In addition to the extra weight required by larger gauge wires of wiring harnesses, automotive plants require inventory space for such components prior to their installation which is labor intensive and hence increases the resultant cost of the vehicle.

Prior art references noted during investigation conducted in connection with the present invention include U.S. Pat. No. 2,904,846 Smith; U.S. Pat. No. 3,290,481 Hurkel; U.S. Pat. No. 4,070,503 Robert; U.S. Pat. No. 4,196,038 Chiba; U.S. Pat. No. 4,520,562 Sado et al.; U.S. Pat. No. 4,635,432 Wheeler; U.S. Pat. No. 4,822,960 Yao; U.S. Pat. No. 4,876,440 Kamath et al.; U.S. Pat. No. 5,191,292 Klotz; U.S. Pat. No. 5,201,903 Corbett et al.; U.S. Pat. No. 5,282,301 Roentgen et al.; U.S. Pat. No. 5,584,122 Kato et al; U.S. Pat. No. 5,708,251 Naveh; U.S. Pat. No. 5,800,645 Gatz; and U.S. Pat. No. 5,849,129 Hogge et al., and by the Japanese patent publication JP-5-303990 of Shiina et al. dated Nov., 1993.

### SUMMARY OF THE INVENTION

One object of the present invention is to provide an improved method for making an electrical distribution conductor.

In carrying out the above object, the method for making an electrical distribution conductor in accordance with the invention is performed by applying an electrical voltage across a pair of spaced rotary electrodes and then engaging an electrically conductive uninsulated wire with the pair of spaced rotary electrodes to pass an electrical current through the wire and heat the wire to a predetermined temperature that is at least approximately as hot as the melting temperature of a thermoplastic member. The heated wire is forced into the thermoplastic member to provide insulated mounting thereof by the thermoplastic member such that the wire provides an electrical conductor between spaced locations.

In one preferred practice of the invention, wire is forced into the thermoplastic member by at least one rotatively driven member and is supplied from a supply roll. More specifically, the preferred practice of the method has the wire: heated by a pair of spaced rotary electrodes, engaged with the pair of rotary electrodes by a pair of rotary members at least one of which is rotatively driven to force the heated wire into the thermoplastic member, and supplied from a supply roll.

The thermoplastic member may be initially heated along a predetermined path into which the heated wire is forced to provide its insulated mounting. This heating is provided by warm air that is impinged with the thermoplastic member prior to the heated wire being forced thereinto to provide the insulated mounting of the wire.

The thermoplastic member may also be cooled in an accelerated manner by a stream of cool air after the wire is forced into the thermoplastic member.

In one practice of the method, the wire is fully embedded along a length thereof within the thermoplastic member, while another practice has the wire partially embedded along a length thereof within the thermoplastic member.

One practice of the method also utilizes another uninsulated wire that is heated and forced into the thermoplastic member in an electrically connected relationship with the first wire, while another practice has another uninsulated wire that is heated and forced into the thermoplastic member in a crossing and electrically insulated relationship with the first wire.

In another preferred practice of the invention, the wire is initially engaged with a leading rotary electrode of the spaced pair of rotary electrodes and is subsequently engaged with a trailing rotary electrode of the spaced pair of electrodes, with the heated wire moving between the trailing rotary electrode and the thermoplastic member, and with the trailing rotary electrode being sufficiently close to the thermoplastic member to force the heated wire into the thermoplastic member.

The immediately preceding practice of the invention may also have the heated wire engaged by a rotary adjusting roll after being forced into the thermoplastic member by the trailing rotary electrode so the adjusting roll ensures proper positioning of the wire within the thermoplastic member. The wire is mounted on the thermoplastic member with a straight shape or with a nonstraight shape. The wire is cut to provide a connection end extending away from the thermoplastic member. An electrical connector is mounted on the thermoplastic member with at least one contact electrically connected to the connection end of the wire.

Another object of the present invention is to provide improved apparatus for making an electrical distribution conductor.

In carrying out the immediately preceding object, the apparatus constructed in accordance with the invention includes a pair of spaced rotary electrodes with which an uninsulated electrically conductive wire is engaged to pass an electrical current through the wire and heat the wire to a predetermined temperature that is at least approximately as hot as the melting point of a thermoplastic member. A drive mechanism of the apparatus forces the heated wire into the thermoplastic member to provide insulated mounting thereof such that the wire provides an electrical conductor between spaced locations.

In one preferred embodiment, the apparatus includes a support on which the pair of rotary electrodes are rotatably mounted in a spaced relationship from each other. A pair of rotary members of the apparatus respectively oppose the pair of rotary electrodes with the wire therebetween to force the wire against the rotary electrodes. The drive mechanism of the apparatus includes a rotary drive for rotatably driving one of the rotary members to move the wire between the rotary electrodes and the rotary members for the heating and to force the wire into the thermoplastic member.

The apparatus includes a spool from which the wire is supplied, and the spool has an electrical insulator that electrically insulates the electrodes from ground through the wire.

The apparatus also includes a guide that is mounted on the support and through which the heated wire is guided to be forced into the thermoplastic member.

A source of hot air of the apparatus heats the thermoplastic member along a predetermined path along which the heated wire is forced into the thermoplastic member, and a source of cool air cools the thermoplastic member after the heated wire has been forced into it.

The apparatus also includes a support on which the pair of spaced electrodes are mounted to function as an end effector of a robot arm.

In another preferred embodiment, the pair of spaced rotary electrodes comprise a leading rotary electrode and a trailing rotary electrode that is positioned sufficiently close to the thermoplastic member to force the heated wire into the thermoplastic member. In this embodiment, the drive mechanism provides relative movement between the pair of spaced rotary electrodes and the thermoplastic member. This embodiment additionally includes at least one adjusting roll for engaging the wire after the trailing rotary electrode to provide proper positioning of the wire on the thermoplastic member.

Another object of the present invention is to provide an improved electric distribution conductor.

In carrying out the immediately preceding object, the electrical distribution conductor of the invention includes a thermoplastic member and also includes a wire that is at least partially embedded within the thermoplastic member by heating of the wire while uninsulated and then forcing the wire into the thermoplastic member to provide insulated mounting thereof such that the wire provides an electrical conductor between spaced locations.

The thermoplastic member of the electrical distribution conductor has particular utility when embodied as a vehicle trim component so as to replace conventional wiring harnesses utilized in vehicles.

In one embodiment, the wire is fully embedded along the length thereof within the thermoplastic member, while another embodiment has the wire partially embedded within the thermoplastic member along a length thereof which has an exposed surface.

In one construction, the thermoplastic member has spaced mounting lugs into which the heated wire is forced to provide its insulated mounting.

The electrical distribution conductor in one construction includes a second uninsulated electrically conductive wire that is at least partially embedded within the thermoplastic member by heating of the second wire while uninsulated and then forcing the heated second wire into the thermoplastic wire and into electrical contact with the first wire in an electrically connected relationship.

In another construction, the electrical distribution conductor includes a second uninsulated electrically conductive wire that is at least partially embedded within the thermoplastic member by heating of the second wire while uninsulated and then forcing the heated second wire into the thermoplastic member and into a crossing relationship with the first wire in an electrically isolated relationship.

In a further construction, the electrical distribution conductor has a wire end projecting away from the thermoplastic member to provide a connection end. An electrical connector is also mounted on the thermoplastic member and has at least one contact electrically connected to the connection end of the wire.

The objects, features and advantages of the present invention are readily apparent from the following detailed description of the best mode for carrying out the invention when taken in connection with the accompanying drawings.

### BRIEF DESCRIPTION OF THE DRAWINGS

FIG. 1 is a somewhat schematic view of one embodiment of apparatus constructed in accordance with the invention to perform the method thereof that makes an electrical distribution conductor in accordance with the invention.

FIG. 2 is a schematic view illustrating the electrical distribution conductor as a vehicle trim component embodied by a door trim panel that provides electrical conductors to associated electrical components of the door without the necessity for any wiring harness.

FIG. 3 is a view that illustrates the manner in which a pair of wires are mounted by a thermoplastic member in a crossing and electrically connected relationship.

FIG. 4 is a view that illustrates the manner in which a pair of wires are mounted by a thermoplastic member in a crossing and electrically isolated relationship.

FIGS. 5 and 6 illustrate another construction that permits a pair of wires to cross each other in an electrically isolated relationship.

FIGS. 7 and 8 illustrate another construction wherein a thermoplastic member has mounting lugs that mount wires at spaced locations.

FIG. 9 is a graph that illustrates current flows necessary to provide heating of two different gauge wires to varying temperatures.

FIG. 10 is a perspective view illustrating another embodiment of apparatus constructed in accordance with the invention to perform the method thereof that makes an electrical distribution connector in accordance with the invention.

FIG. 11 is a partial view of FIG. 10 taken on an enlarged scale to show the manner in which a wire is embedded in a thermoplastic member in accordance with the invention.

FIG. 12 is a top plan view taken along the direction of line 12-12 in FIG. 10 to illustrate the manner in which the wire is embedded into the thermoplastic member along a straight path.

FIG. 13 is a top plan view similar to FIG. 12 but illustrating the manner in which the wire is embedded in the thermoplastic member along a nonstraight path.

FIG. 14 is a partial perspective view illustrating the manner in which one or more embedded wires in the thermoplastic member have cut ends that project away from the thermoplastic member to permit electrical connection to the wire.

FIG. 15 is a sectional view taken through the thermoplastic member and an electrical connector mounted on the thermoplastic member such that contacts thereof electrically connect with the wire connection ends.

### DETAILED DESCRIPTION OF THE PREFERRED EMBODIMENTS

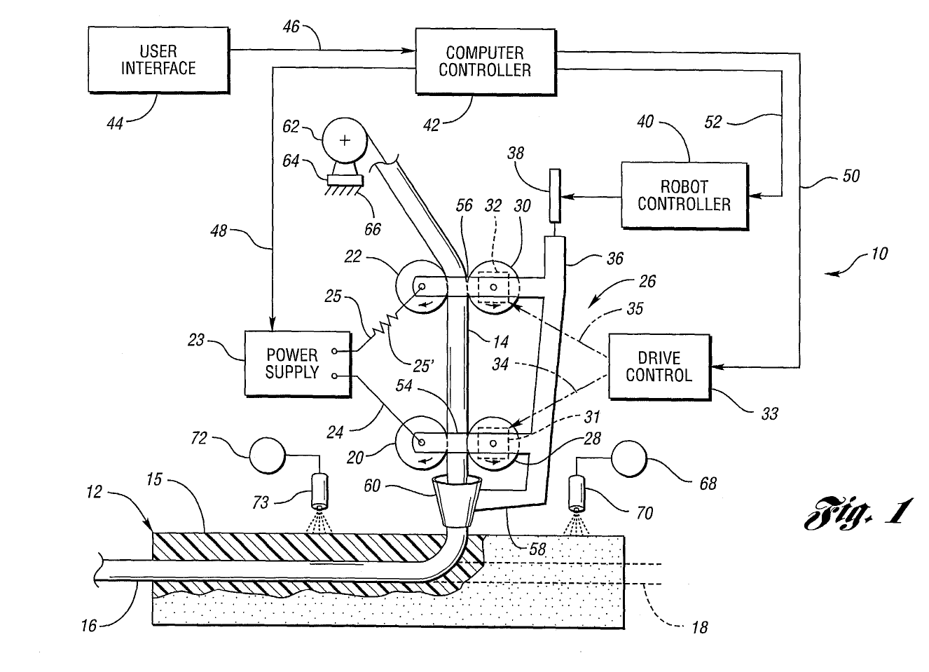

With reference to FIG. 1, one embodiment of apparatus constructed in accordance with the invention to perform the method thereof is generally indicated by 10 and is operable to make an electrical distribution conductor 12 for providing an electrical conductor between spaced locations in accordance with the invention. The apparatus 10 as well as its method of operation and the resultant product will be described in an integrated manner to facilitate an understanding of all aspects of the invention.

With continuing reference to FIG. 1, the apparatus 10 operates to heat an electrically conductive uninsulated wire 14 to a predetermined temperature that is at least approximately as hot as the melting temperature of a thermoplastic member 15 and to force the heated wire into the thermoplastic member to provide insulated mounting of the wire by the thermoplastic member such that the wire provides an electrical conductor between spaced locations 16 and 18 for electrical power distribution. The heating is provided by a pair of spaced rotary electrodes 20 and 22 with which the wire 14 is engaged and which are connected to a power supply 23 that provides a predetermined electrical current by way of the wire connections 24 and 25, the latter of which includes a resistor 25′ for limiting current flow. An electrical current thus flows through the wire 14 to provide its heating between the electrodes 20 and 22. A drive mechanism 26 of the apparatus 10 includes a pair of rotary members 28 and 30 that respectively oppose the pair of electrodes 20 and 22. At least one of the rotary members 28 or 30, preferably the lower rotary member 28, is rotatively driven by an associated drive motor. As illustrated, both of the rotary members 28 and 30 are rotatively driven by drive motors 31 and 32, respectively, under the operation of a drive control 33 through associated control connection 34 and 35. The apparatus 10 includes a support 36 that is mounted on the end of a robot arm 38 on which the electrodes 20 and 22 and the rotary members 28 and 30 are mounted such that the apparatus functions as an end effector under the operation of a robot controller 40.

A computer controller 42 of the apparatus is operated by a user interface 44 through a connection 46 and has a connection 48 to the power supply 23, a connection 50 to the drive controller 33, and a connection 52 to the robot controller 40. The heating and driving of the wire 14 are thus controlled as is the movement of the robot arm 38 in order to control the depth to which the wire is melted into the thermoplastic member 15 for its insulated mounting. As illustrated in FIG. 9, the current flows for different gauge wires provides varying temperatures assuming that the wire is driven sufficiently slow to allow it to reach its fully heated state for the predetermined temperature to be used for the thermoplastic material involved. That temperature should be approximately as great as the melting temperature of the thermoplastic member used. Also, the power source could be AC, but a DC source is believed to provide better power control and may function best with pulse width modulation.

The support 36 of the drive mechanism 26 illustrated in FIG. 1 includes a pair of spaced arms 54 and 56 on which the pair of rotary electrodes 20 and 22 are respectively rotatably mounted such that the wire 14 is rollingly engaged with the electrodes. Furthermore, the pair of rotary members 28 and 30 are respectively rotatably mounted on the pair of arms 54 and 56 in an opposed relationship to the electrodes 20 and 22 with the wire 14 therebetween so as to be heated and driven downwardly into the thermoplastic member 15. The support 36 also includes a lower arm 58 that supports a guide 60 through which the wire 14 is guided to the thermoplastic member 15 to reduce any buckling possibility of the wire during the heating and driving operation.

It is possible to supply the wire 14 in discrete lengths as required for the particular spacing of the location 16 and 18 to be electrically connected. However, large production jobs can be enhanced by the use of a wire supply spool 62 that supplies the wire 14. A suitable cutting operation is thus utilized at the end of each cycle so that the wire has an appropriate length for its connection locations. An electrical insulator 64 electrically insulates the spool 62 from ground 66 so that current does not flow from the wire 14 to the spool and thereby disrupt the heating process.

It is also possible for the apparatus to include a source 68 of warm air that is supplied through a conduit outlet 70 to the thermoplastic member 15 along a predetermined path along which the heated wire 14 is to be forced into the thermoplastic member. This warm air provides preheating of the thermoplastic member to facilitate the forcing of the heated wire 14 into the thermoplastic member. Furthermore, a source of cool air 72 supplies cool air through a conduit outlet 73 to the thermoplastic member 15 after the wire 14 has been forced into it such that the cool air provides accelerated cooling of the plastic.

With reference to FIG. 2, the present invention has particular utility for use with vehicle trim components such as the vehicle door trim panel 74 shown. More specifically, the wires 14 are mounted within the thermoplastic door trim panel 74 by the process described above to provide operation of an accessory light 76, a window regulator drive motor 78, and an outside rear view mirror control cable 80. Switches 82 provide control of the electrical operations. Any suitable type of connectors 84 provide electrical connection to these electrical components. Certain of the wires 14 have electrical connections 86 to each other while others of the crossing wires are electrically insulated from each other as identified by 88 and as is hereinafter more fully described.

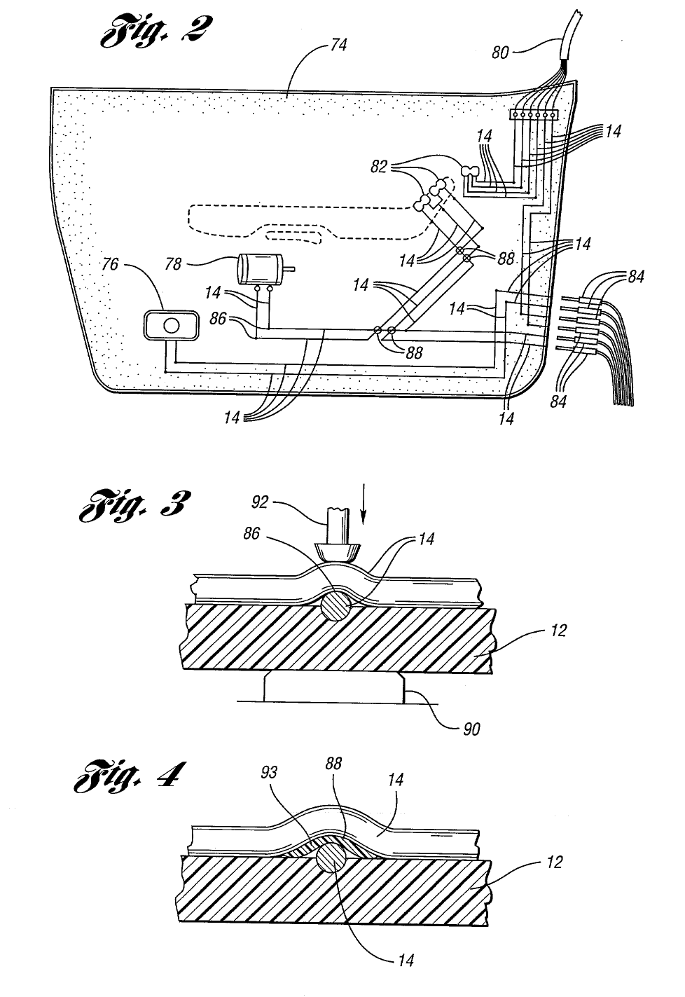

With reference to FIG. 3, the two wires 14 are each mounted by the thermoplastic member 15 by the apparatus and process previously described in connection with FIG. 1. At their crossing junction 86, the wires 14 are engaged with each other by operation of an anvil 90 and a tool 92 that force the wires into electrical contact, and an electrical current is applied to provide a resistive weld joint at the wire junction.

With reference to FIG. 4, two crossing wires 14 which are also both mounted by the thermoplastic member in the same manner previously described are electrically isolated from each other at 88 by a piece of tape 93.

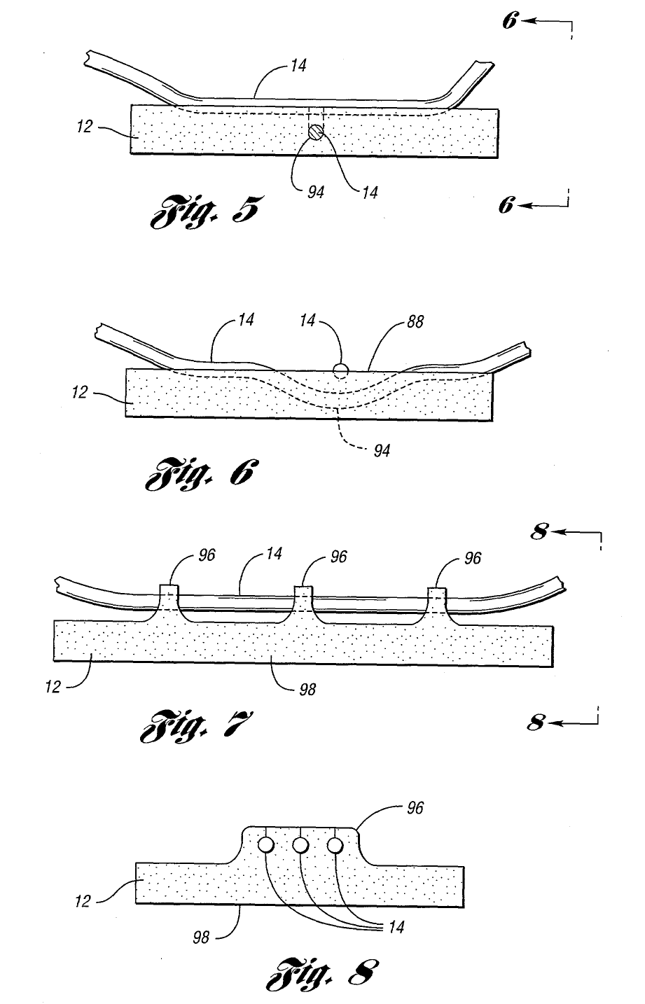

FIGS. 5 and 6 illustrate another construction for providing the crossing wires 14 in an electrically isolated relationship from each other by having one of the wires penetrate further into the thermoplastic member at location 94 where the isolated crossing 88 is located.

It will be noted that at each of the embodiments illustrated in FIGS. 3-6, the wires 14 at certain locations are only partially embedded within the thermoplastic member 15 and have a length with an exposed surface. In other applications it may be necessary for the wire to be fully embedded within the thermoplastic member 15 as previously described and illustrated in FIG. 1. In the former case, there will be observable softened and recooled plastic along the wire at each side of its exposed surface. Likewise, the thermoplastic member 15 illustrated in FIG. 1 will have observable softened and recooled plastic along the predetermined path at which the heated wire is embedded within the thermoplastic member.

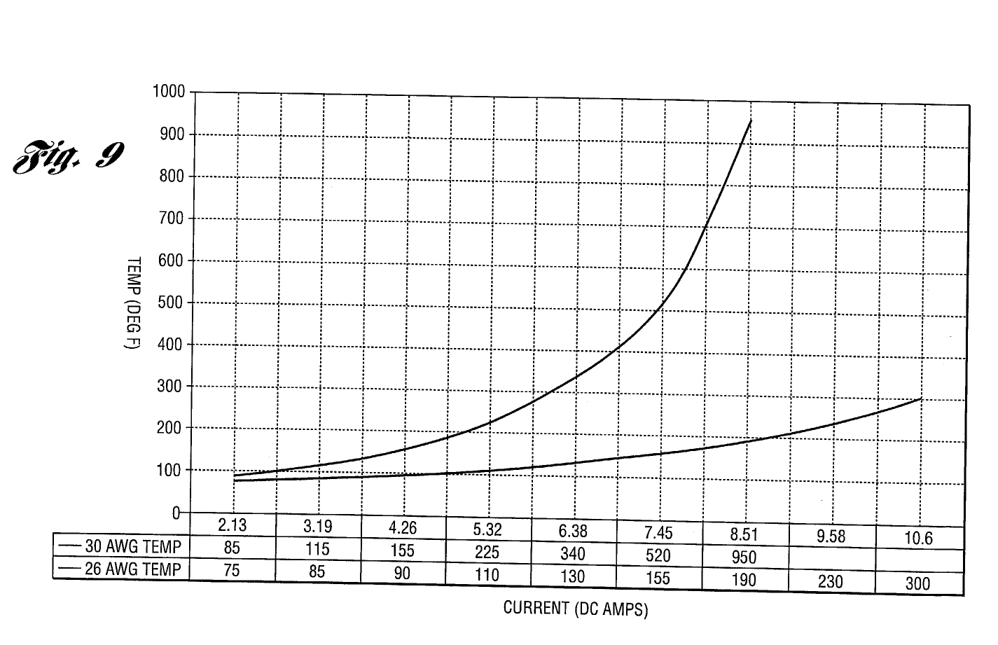

With reference to FIGS. 7 and 8, the thermoplastic member 15 is illustrated as having spaced mounting lugs 96 at which the wires 14 are mounted by the heating and driving process previously described in connection with FIG. 1. This construction is believed to be desirable for larger gauge wires to prevent any distortion of the oppositely facing surface 98 due to the heating and cooling of the greater mass of plastic.

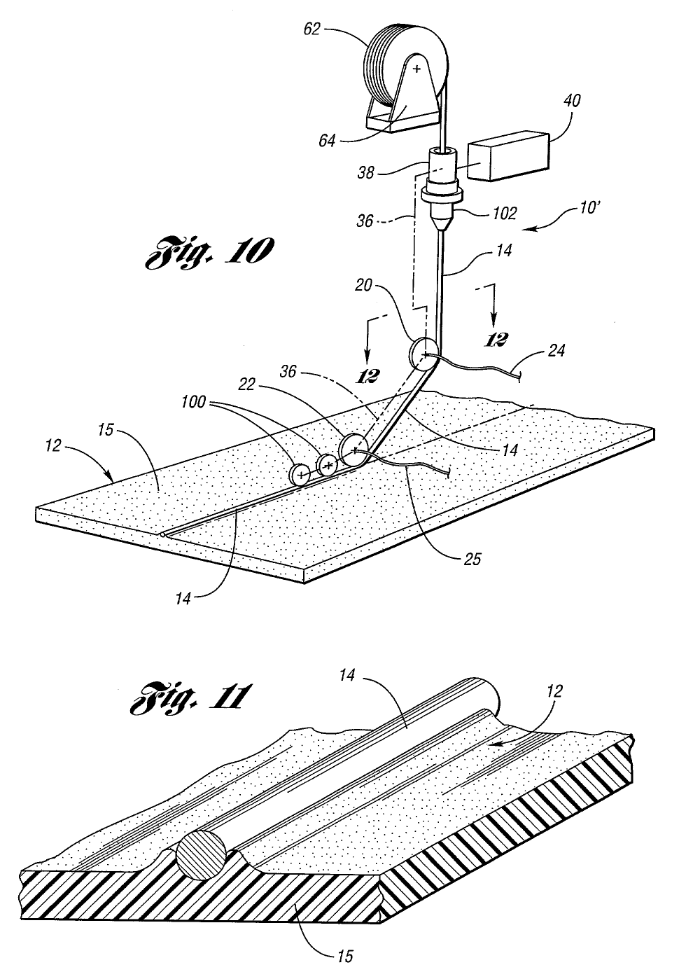

With reference to FIG. 10, another embodiment of the apparatus 10′ is somewhat similar to the previously described embodiment such that like reference numerals are applied to like components thereof and much of the previous description is applicable so it will not to be repeated. However, in this embodiment, the pair of spaced rotary electrodes includes a leading rotary electrode 20 mounted on the support 36 and also includes a trailing spaced electrode 22 that is mounted on the support 26. The wire 14 thus initially engages the leading rotary electrode 20 and then passes to the trailing rotary electrode 22. The electrical voltage applied across the leading and trailing rotary electrodes 20 and 22 by the power supply connections 24 and 25 passes a current through the wire between the electrodes so as to heat the wire as previously described to a temperature that is at least approximately as hot as the thermoplastic member 15. The trailing rotary electrode 22 is spaced sufficiently close to the thermoplastic member 15 so that the heated wire is forced into the thermoplastic member as illustrated in FIG. 11 where this is shown in a partially embedded mounting.

With continuing reference to FIG. 10, the apparatus 10′ also includes at least one rotary adjusting roll 100 rotatably mounted on the support 36 to rotatably engage the wire 14 downstream from the trailing rotary electrode 22 so as to properly position the wire within the thermoplastic member. With this embodiment, the support 36 may be mounted on a robot end effector 38 as previously described and moved by a robot controller 40 such that the robot functions as the drive mechanism for providing relative movement between the thermoplastic member 15 and the apparatus so as to draw the wire 14 from the spool 62 through a guide 102 prior to engaging the leading rotary electrode 20. The robot end effector 38 and robot controller 40 thus function as the drive mechanism of the apparatus. It should be appreciated that it is also possible to hold the apparatus stationary and move the thermoplastic member 15 by a suitable workpiece carrier whose drive thus functions as the drive mechanism of the apparatus.

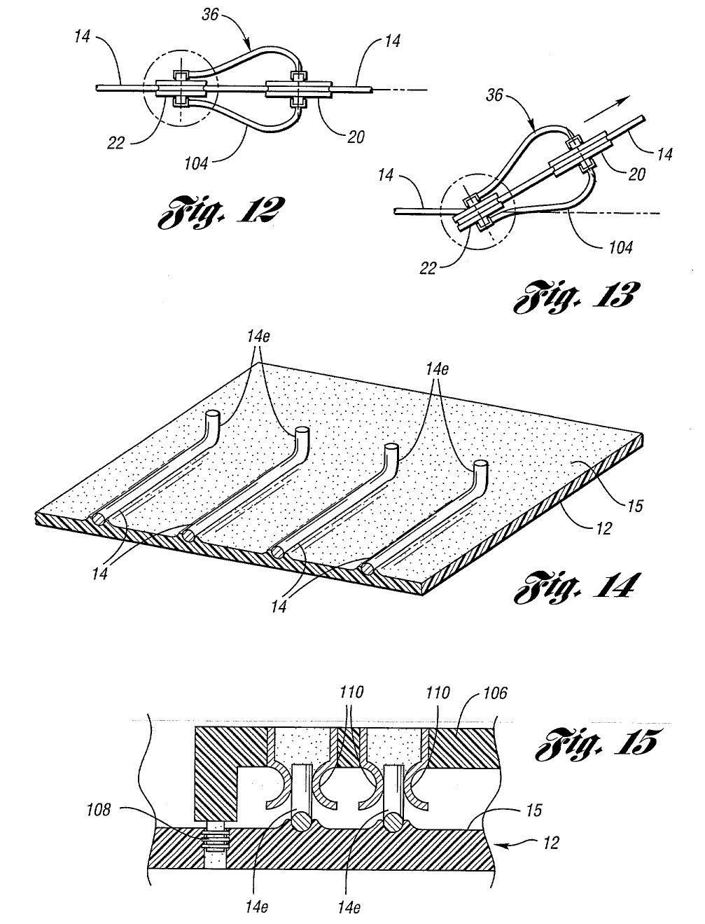

With reference to FIGS. 12 and 13, the support 36 includes a support bracket 104 that mounts the leading and trailing rotary electrodes 20 and 22 and also permits rotation thereof about a vertical axis that extends downwardly from the guide 102 (FIG. 6). This construction permits the wire 14 to be embedded within the thermoplastic member in a straight shape upon movement along a straight path as shown in FIG. 2 and also permits rotation thereof about the vertical axis as shown in FIG. 13 so as to permit the wire to be moved in a curved or other non straight shape.

With reference to FIG. 14, each of the wires 14 illustrated has a cut end 14e that functions as a connection end extending away from the thermoplastic member 15. An electrical connector 106 has suitable fasteners 108 (only one shown) for providing mounting thereof on the thermoplastic member 15 and includes at least one contact 110 that is electrically connected to the connection end 14e of each wire.

The present invention thus advantageously integrates electrical distribution systems into thermoplastic parts such as vehicle trim panels or the like. This results in lower material costs since smaller diameter wires can be utilized and also results in lower labor costs by eliminating assembly operations as well as providing the possibility of electrical testing during the manufacturing process, reduction of weight due to elimination of vehicle harness connectors, elimination of buzz, squeak and rattle problems, automated robotic operation, provision of cassette or modular products, and other apparent advantages. Also, solid wires can be utilized as opposed to stranded wires that are necessary with vehicle wire harnesses that flex.

In heating the wire, its predetermined heated temperature may be slightly lower than the melting temperature of the thermoplastic member so long as it is hot enough to soften and deform the thermoplastic member to provide the wire mounting as described.

While the best modes for carrying out the invention have been described in detail, those familiar with the art to which this invention relates will recognize various alternative designs and embodiments for practicing the invention as defined by the following claims.

What is claimed is:

1. A method for making an electrical distribution conductor comprising:
applying an electrical voltage across a pair of spaced rotary electrodes;
engaging an electrically conductive uninsulated wire with the pair of spaced rotary electrodes to pass an electrical current through the wire and heat the wire to a predetermined temperature that is at least approximately as hot as the melting temperature of a thermoplastic member; and
forcing the heated wire into the thermoplastic member to provide insulated mounting of the wire by the thermoplastic member such that the wire provides an electrical conductor between spaced locations.

2. A method for making an electrical distribution conductor as in claim 1 wherein the wire is forced into the thermoplastic member by at least one rotatively driven member.

3. A method for making an electrical distribution conductor as in claim 1 wherein the wire is supplied from a supply spool.

4. A method for making an electrical distribution conductor as in claim 1 wherein the thermoplastic member is initially heated along a predetermined path into which the heated wire is forced to provide its insulated mounting.

5. A method for making an electrical distribution conductor as in claim 4 wherein warm air is impinged with the thermoplastic member to provide additional heating prior to the heated wire being forced thereinto to provide the insulated mounting of the wire.

6. A method for making an electrical distribution conductor as in claim 1 wherein a cool air stream provides accelerated cooling of the thermoplastic member after the wire is forced into it.

7. A method for making an electrical distribution conductor as in claim 1 wherein the wire is fully embedded along a length thereof within the thermoplastic member.

8. A method for making an electrical distribution conductor as in claim 1 wherein the wire is partially embedded along a length thereof within the thermoplastic member.

9. A method for making an electrical distribution conductor as in claim 1 wherein another uninsulated wire is heated and forced into the thermoplastic member in an electrically connected relationship with the first mentioned wire.

10. A method for making an electrical distribution conductor as in claim 1 wherein another uninsulated wire is heated and forced into the thermoplastic member in a crossing and electrically insulated relationship with the first mentioned wire.

11. A method for making an electrical distributor as in claim 1 wherein the wire is initially engaged with a leading rotary electrode of the spaced pair of rotary electrodes and is subsequently engaged with a trailing rotary electrode of the spaced pair of rotary electrodes, with the heated wire moving between the trailing rotary electrode and the thermoplastic member, and with the trailing rotary electrode being sufficiently close to the thermoplastic member to force the heated wire into the thermoplastic wire.

12. A method for making an electrical distributor as in claim 11 wherein the heated wire is engaged by a rotary adjusting roll after being forced into the thermoplastic member by the trailing rotary electrode so the adjusting roll ensures proper positioning of the wire within the thermoplastic member.

13. A method for making an electrical distributor as in claim 1 wherein the wire is mounted on the thermoplastic member with a straight shape.

14. A method for making an electrical distributor as in claim 1 wherein the wire is mounted on the thermoplastic member with a nonstraight shape.

15. A method for making an electrical distributor as in claim 1 wherein the wire is cut to provide a connection end extending away from the thermoplastic member.

16. A method for making an electrical distributor as in claim 15 wherein an electrical connector is mounted on the thermoplastic member with at least one contact electrically connected to the connection end of the wire.

17. A method for making an electrical distribution conductor comprising:
applying an electrical voltage between a pair of spaced rotary electrodes;
engaging an electrically conductive uninsulated wire with the pair of spaced rotary electrodes by a pair of rotary members to pass an electrical current through the wire to provide heating thereof to a predetermined temperature that is at least approximately as hot as the melting temperature of a thermoplastic member; and
rotating at least one of the rotary members to move the wire past the pair of rotary electrodes for the heating and to force the heated wire into the thermoplastic member to provide insulated mounting of the wire by the thermoplastic member such that the wire provides an electrical conductor between spaced locations.

18. A method for making an electrical distribution conductor comprising:
impinging hot air with a thermoplastic member along a predetermined path to provide heating thereof;
applying an electrical voltage between a pair of spaced rotary electrodes;
engaging an electrically conductive uninsulated wire against the pair of rotary electrodes by a pair of rotary members to pass an electrical current through the wire to provide heating thereof to a predetermined temperature that is at least approximately as hot as the melting temperature of the thermoplastic member;
rotating at least one of the rotary members to move the wire past the pair of rotary electrodes for the heating and to force the heated wire into the thermoplastic member along the predetermined path to provide insulated mounting of the wire by the thermoplastic member such that the wire provides an electrical conductor between spaced locations; and
impinging cool air with the thermoplastic member along the predetermined path to provide cooling thereof where the wire is mounted.

19. A method for making an electrical distribution conductor comprising:
applying an electrical voltage between a leading rotary electrode and a trailing rotary electrode;
engaging an electrically conductive uninsulated wire with the leading and trailing rotary electrodes to pass an electrical current through the wire to provide heating thereof to a predetermined temperature that is at least approximately as hot as the melting temperature of the thermoplastic member; and
providing relative movement between the trailing rotary electrode and the thermoplastic member with the trailing rotary electrode sufficiently close to the thermoplastic member to force the heated wire into the thermoplastic member to provide insulated mounting of the wire by the thermoplastic member such that the wire provides an electrical conductor between spaced locations.

20. Apparatus for making an electrical distribution conductor comprising:
a pair of spaced rotary electrodes with which an uninsulated electrically conductive wire is engaged to pass an electrical current through the wire and heat the wire to a predetermined temperature that is at least approximately as hot as the melting temperature of a thermoplastic member; and
a drive mechanism for forcing the heated wire into the thermoplastic member to provide insulated mounting thereof such that the wire provides an electrical conductor between spaced locations.

21. Apparatus for making an electrical distribution conductor as in claim 20 further including a support on which the pair of rotary electrodes are rotatably mounted in a spaced relationship from each other.

22. Apparatus for making an electrical distribution conductor as in claim 21 further including a pair of rotary members that respectively oppose the pair of rotary electrodes with the wire therebetween to force the wire against the rotary electrodes, and the drive mechanism including a rotary drive for rotatably driving one of the rotary members to move the wire between the rotary electrodes and the rotary members for the heating and to force the wire into the thermoplastic member.

23. Apparatus for making an electrical distribution conductor as in claim 22 further including a spool from which the wire is supplied, and the spool having an electrical insulator that electrically insulates the electrodes from ground through the wire.

24. Apparatus for making an electrical distribution conductor as in claim 20 further including a guide that is mounted on the support and through which the heated wire is guided to be forced into the thermoplastic member.

25. Apparatus for making an electrical distribution conductor as in claim 20 further including a source of hot air that heats the thermoplastic member along a predetermined path along which the heated wire is forced into the thermoplastic member.

26. Apparatus for making an electrical distribution conductor as in claim 20 further including a source of cool air that cools the thermoplastic member after the heated wire has been forced into it.

27. Apparatus for making an electrical distribution conductor as in claim 20 further including a source of warm air that heats the thermoplastic member along a predetermined path along which the heated wire is forced into the thermoplastic member, and a source of cool air that cools the thermoplastic member after the heated wire has been forced into it.

28. Apparatus for making an electrical distribution conductor as in claim 16 further including a robot arm on which the pair of spaced electrodes are mounted to function as an end effector of the robot arm.

29. Apparatus for making an electrical distribution conductor as in claim 20 wherein the pair of spaced rotary electrodes comprise a leading rotary electrode and a trailing rotary electrode that is positioned sufficiently close to the thermoplastic member to force the heated wire into the thermoplastic member, and the drive mechanism providing relative movement between the pair of spaced rotary electrodes and the thermoplastic member.

30. Apparatus for making an electrical distribution conductor as in claim 29 further including at least one adjusting roll for engaging the wire after the trailing rotary electrode to provide proper positioning of the wire on the thermoplastic member.

31. Apparatus for making an electrical distribution conductor comprising:
a support;
a pair of spaced electrodes rotatably mounted on the support in a spaced relationship from each other;
a pair of rotary members that respectively oppose the pair of rotatable electrodes such that an uninsulated electrically conductive wire is engaged therewith to pass an electrical current through the wire to heat the wire to a predetermined temperature that is at least approximately as hot as the melting temperature of a thermoplastic member; and
a drive mechanism for rotating at least one of the rotary members to force the heated wire into the thermoplastic member to provide insulated mounting thereof such that the wire provides an electrical conductor between spaced locations.

32. Apparatus for making an electrical distribution conductor comprising:
a source of warm air for heating a thermoplastic member along a predetermined path;
a spool of uninsulated electrically conductive wire, and the spool having an insulator that insulates the wire thereon from ground;
a support;
a pair of spaced electrodes rotatably mounted on the support in a spaced relationship from each other;
a pair of rotary members rotatably mounted on the support to respectively oppose the pair of rotatable electrodes such that a length of the wire received therebetween from the spool has an electrical current passed therethrough to heat the wire to a predetermined temperature that is at least approximately as hot as the melting temperature of a thermoplastic member;
a drive mechanism for rotating at least one of the rotary members to forcing the heated wire into the thermoplastic member along the predetermined path to provide insulated mounting thereof such that the wire provides an electrical conductor between spaced locations; and
a source of cool air for cooling the thermoplastic member along the predetermined path with the wire mounted in the thermoplastic member.

33. An electrical distribution conductor comprising:
a thermoplastic member; and
a wire that is at least partially embedded within the thermoplastic member by heating of the wire while uninsulated and then forcing the heated wire into the thermoplastic member to provide insulated mounting thereof such that the wire provides an electrical conductor between spaced locations.

34. An electrical distribution conductor as in claim 33 wherein the thermoplastic member is a vehicle trim component.

35. An electrical distribution conductor as in claim 33 wherein the wire is fully embedded along a length thereof within the thermoplastic member.

36. An electrical distribution conductor as in claim 33 wherein the wire is partially embedded within the thermoplastic member along a length thereof which has an exposed surface.

37. An electrical distribution conductor as in claim 33 wherein the thermoplastic member has spaced mounting lugs into which the wire is forced to provide its insulated mounting.

38. An electrical distribution conductor as in claim 33 further including a second uninsulated electrically conductive wire that is at least partially embedded within the thermoplastic member by heating of the second wire while uninsulated and then forcing the heated second wire into the thermoplastic member and into electrical contact with the first mentioned wire in an electrically connected relationship.

39. An electrical distribution conductor as in claim 33 further including a second uninsulated electrically conductive wire that is at least partially embedded within the thermoplastic member by heating of the second wire while uninsulated and then forcing the heated second wire into the thermoplastic member and into a crossing relationship with the first mentioned wire in an electrically isolated relationship.

40. An electrical distribution conductor as in claim 33 which has a wire end projecting away from the thermoplastic member to provide a connection end.

41. An electrical distribution conductor as in claim 40 further including an electrical connector mounted on the thermoplastic member and having at least one contact electrically connected to the connection end of the wire.

42. A vehicle trim assembly comprising:
a thermoplastic trim member for a vehicle; and
a wire that is at least partially embedded within the thermoplastic trim member by heating of the wire while uninsulated and then forcing the heated wire into the thermoplastic trim member to provide insulated mounting thereof such that the wire provides an electrical conductor between spaced locations.
